(19) United States
(12) Patent Application Publication
(10) Pub. No.: US 2012/0182272 A1
(43) Pub. Date: Jul. 19, 2012

(54) ELECTRONIC WRITING DEVICE, ELECTRONIC WRITING METHOD, AND COMPUTER READABLE MEDIUM

(75) Inventors: Kazushige OOI, Kanagawa (JP); Eisuke Osakabe, Kanagawa (JP); Hiroyuki Funo, Kanagawa (JP); Tomonari Takahashi, Kanagawa (JP)

(73) Assignee: FUJI XEROX CO., LTD., TOKYO (JP)

(21) Appl. No.: 13/192,211

(22) Filed: Jul. 27, 2011

(30) Foreign Application Priority Data
Jan. 14, 2011 (JP) 2011-005411

(51) Int. Cl. G06F 3/033

(52) U.S. Cl. 345/179

(57) ABSTRACT

An electronic writing device includes a light source, an image sensor, a detecting unit, table information, and a controller. The light source emits light to a recording medium. The image sensor receives the light reflected from the recording medium as image data. The detecting unit detects a light quantity of the image data received by the image sensor. In the table information, a light-quantity range and a control object for the image sensor or the light source are associated with each other. The light-quantity range is segmented into multiple threshold values. The controller controls the operation of the image sensor or the light source, every time the image sensor receives new image data, on the basis of the light quantity of the image data detected by the detecting unit and the table information.

### CROSS-REFERENCE TO RELATED APPLICATIONS

This application is based on and claims priority under 35 USC 119 from Japanese Patent Application No. 2011-005411 filed Jan. 14, 2011.

### BACKGROUND

### TECHNICAL FIELD

The present invention relates to electronic writing devices, electronic writing methods, and computer readable media.

### SUMMARY

According to an aspect of the invention, there is provided an electronic writing device including a light source, an image sensor, a detecting unit, table information, and a controller. The light source emits light to a recording medium. The image sensor receives the light reflected from the recording medium as image data. The detecting unit detects a light quantity of the image data received by the image sensor. In the table information, a light-quantity range and a control object for the image sensor or the light source are associated with each other. The light-quantity range is segmented into multiple threshold values. The controller controls the operation of the image sensor or the light source, every time the image sensor receives new image data, on the basis of the light quantity of the image data detected by the detecting unit and the table information.

### BRIEF DESCRIPTION OF THE DRAWINGS

An exemplary embodiment of the present invention will be described in detail based on the following figures, wherein:

FIG. 1 schematically illustrates the configuration of an electronic writing device according to an exemplary embodiment;

FIG. 2A is a block diagram illustrating the configuration of a controller shown in FIG. 1, and FIG. 2B is a block diagram illustrating the configuration of an image processing unit shown in FIG. 2A;

FIG. 3 illustrates the structure of each of cells included in a CMOS image sensor;

FIG. 4 illustrates the configuration of the CMOS image sensor;

FIG. 5 is a timing chart illustrating an operational state of the CMOS image sensor;

FIGS. 6A to 6F illustrate examples of table information stored in a memory;

FIG. 7 illustrates the relationship between light-quantity values and set values included in each piece of table information shown FIGS. 6A to 6F;

FIG. 8 is a flow chart illustrating a process executed by an overall control unit;

FIG. 9 illustrates another example of the relationship between light-quantity values and set values included in each piece of table information; and

FIG. 10 is a flow chart illustrating another example of a process executed by the overall control unit.

### DETAILED DESCRIPTION

An exemplary embodiment of the invention will be described below with reference to the drawings.

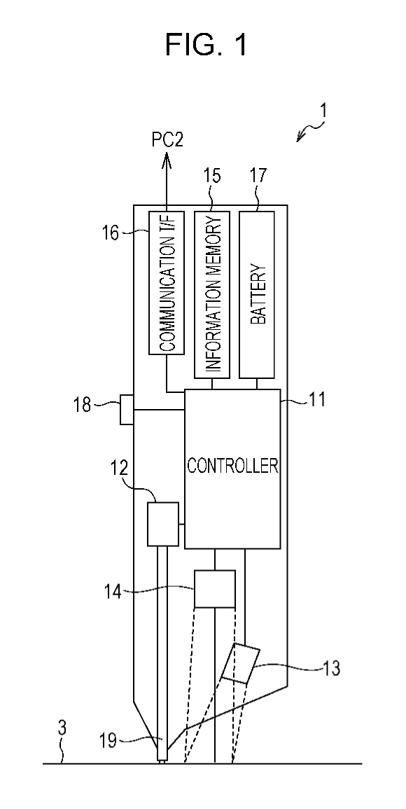

FIG. 1 schematically illustrates the configuration of an electronic writing device according to this exemplary embodiment.

In FIG. 1, an electronic writing device according to this exemplary embodiment is a digital pen 1. The digital pen 1 includes a controller 11, a pressure sensor 12, a light-emitting diode (LED) 13 corresponding to a light source, a complementary-metal-oxide-semiconductor (CMOS) image sensor 14 corresponding to an image sensor, an information memory 15, a communication interface (I/F) 16, a battery 17, a switch 18, and a pen tip 19. The controller 11 controls the overall operation of the digital pen 1 and includes a microcomputer, a memory, and the like. The controller 11 is connected to the pressure sensor 12 that detects a writing movement of the digital pen 1 on the basis of pressure applied to the pen tip 19. Furthermore, the controller 11 is connected to the LED 13 that emits infrared light onto a sheet 3 and is also connected to the CMOS image sensor 14 that detects the infrared light reflected from the sheet 3 so as to read a code pattern image. Moreover, the controller 11 is connected to the information memory 15 for storing identification information and positional information, to be described later, the communication I/F 16 for communicating with an external apparatus, such as a personal computer (PC) 2, the battery 17 for driving the digital pen 1, and the switch 18 for switching operation modes of the digital pen 1.

Examples of the operation modes of the digital pen 1 include a writing mode and an option mode. A writing mode is a mode in which a character or a pattern written with the digital pen 1 is transmitted to the PC 2. An option mode is a mode in which, for example, the controller 11 causes the CMOS image sensor 14 to read a code pattern image from a specific region on the sheet 3 and transmits the code pattern image to the PC 2 via the communication I/F 16. When the switch 18 is pressed, the writing mode or the option mode is alternately set in the controller 11.

The code pattern image is printed in an invisible form on the sheet 3. The code pattern image includes an identification code corresponding to identification information and a positional code corresponding to positional information. The identification information is used for identifying the sheet 3 and is, for example, a serial number. The positional information is used for specifying a position on the sheet 3. For example, the positional information is used for specifying a position on the sheet 3 on the basis of an X-Y coordinate system.

When a user uses the digital pen 1 in the writing mode to write a character or a pattern on the sheet 3, the LED 13 emits infrared light onto the sheet 3, and the CMOS image sensor 14 detects the infrared light reflected from the sheet 3 so as to read the code pattern image. From the read code pattern image, the controller 11 acquires information about the character or the pattern (i.e., positional information) and the identification information, and transmits the information about the character or the pattern and the identification information to the PC 2 via the communication I/F 16.

A tilt angle of the digital pen 1 relative to the sheet 3 varies depending on each user using the digital pen 1. Moreover, the digital pen 1 may be used indoors or outdoors. An output of the code pattern image received by the controller 11 from the CMOS image sensor 14 fluctuates depending on the state and the environment in which the digital pen 1 is used. Therefore, in order for the controller 11 to accurately read the information about the character or the pattern from the code pattern image, such fluctuations in the output of the code pattern image should be minimized. In this exemplary embodiment, the controller 11 adjusts the exposure time of the CMOS image sensor 14, the output gain of the CMOS image sensor 14, or the quantity of light emitted from the LED 13 so as to minimize fluctuations in the output of the code pattern image.

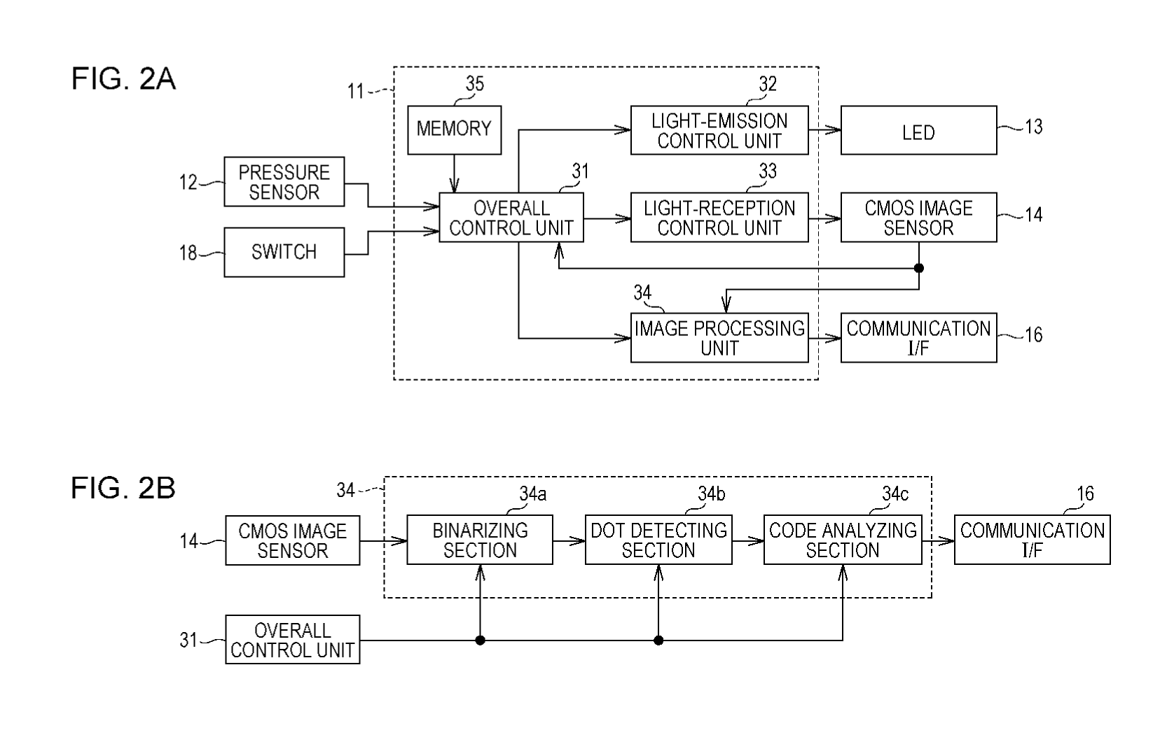

FIG. 2A is a block diagram illustrating the configuration of the controller 11 shown in FIG. 1.

The controller 11 includes an overall control unit 31 corresponding to a detecting unit and a controller, a light-emission control unit 32, a light-reception control unit 33, an image processing unit 34, and a memory 35. The overall control unit 31 controls the light-emission control unit 32, the light-reception control unit 33, and the image processing unit 34 on the basis of signals input from the pressure sensor 12 and the switch 18. Moreover, the overall control unit 31 detects a light quantity of data input from the CMOS image sensor 14. Based on the light quantity of the data input from the CMOS image sensor 14 and table information, to be described later, stored in the memory 35, the overall control unit 31 sets the control object for the LED 13 in the light-emission control unit 32 and sets the control object for the CMOS image sensor 14 in the light-reception control unit 33.

Based on the set control object for the LED 13, the light-emission control unit 32 controls light-emission operation of the LED 13. Based on the set control object for the CMOS image sensor 14, the light-reception control unit 33 controls light-reception operation of the CMOS image sensor 14. Based on a command received from the overall control unit 31, the image processing unit 34 performs image-processing on the data input from the CMOS image sensor 14 and outputs the image-processed data to the communication I/F 16.

FIG. 2B is a block diagram illustrating the configuration of the image processing unit 34 shown in FIG. 2A.

The image processing unit 34 includes a binarizing section 34a, a dot detecting section 34b, and a code analyzing section 34c. The binarizing section 34a binarizes and outputs the data input from the CMOS image sensor 14 for each pixel. The dot detecting section 34b detects a dot from the binarized data. The code analyzing section 34c analyzes the code pattern image from an array of detected dots, acquires information, such as the identification information and the positional information, from the analyzed code pattern image, and outputs the acquired information to the communication I/F 16. The information output from the code analyzing section 34c is temporarily stored in the information memory 15, where necessary. The binarizing process performed in the binarizing section 34a, the dot detecting process performed in the dot detecting section 34b, and the code analyzing process performed in the code analyzing section 34c are collectively referred to as a decoding process.

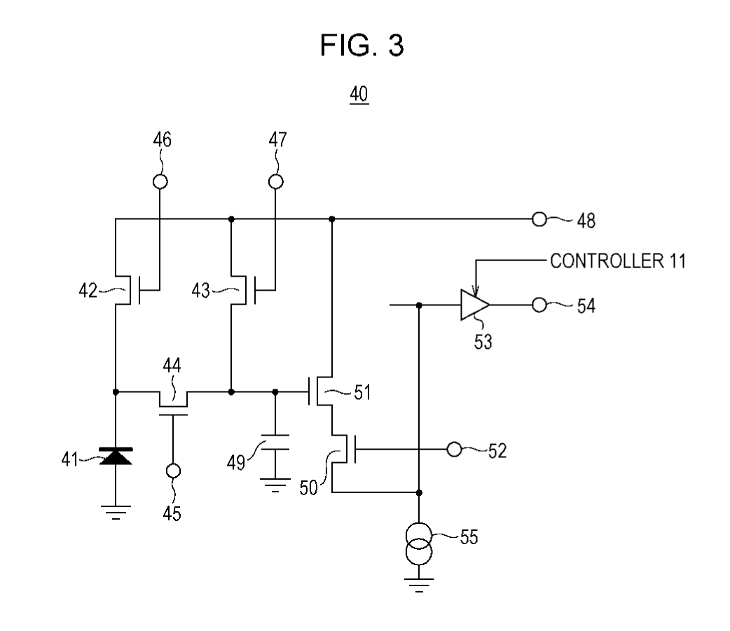

FIG. 3 illustrates the structure of each of cells included in the CMOS image sensor 14.

Each cell 40 included in the CMOS image sensor 14 includes a photodiode 41, transistors 42 and 43, a charge-transfer switch 44, a charge-transfer gate 45, reset terminals 46 and 47, a power-source terminal 48, and a charge-storage capacitor 49. Furthermore, each cell 40 also includes a row-selecting transistor 50, a charge-reading transistor 51, a row-selecting terminal 52, an amplifier 53, an output terminal 54, and a constant current source 55. The power-source terminal 48 is connected to the battery 17 (not shown). The charge-transfer gate 45, the reset terminals 46 and 47, and the output terminal 54 are connected to the controller 11 (not shown).

The photodiode 41 performs photoelectric conversion on input light and stores an electric charge. The controller 11 turns the transistor 42 on and off via the reset terminal 46 so as to determine a charge-storage time in the photodiode 41, that is, an exposure time. Furthermore, the controller 11 turns on the charge-transfer switch 44 via the charge-transfer gate 45 so as to store the electric charge into the charge-storage capacitor 49 from the photodiode 41. Moreover, the controller 11 turns the transistor 42 on and off via the reset terminal 47 so as to initialize the charge-storage capacitor 49 after the electric charge has been read therefrom. When a row selection signal is input to the row-selecting transistor 50 via the row-selecting terminal 52, the electric charge stored in the charge-storage capacitor 49 is input to the amplifier 53 as voltage. The amplifier 53 amplifies data in accordance with an output gain value from the controller 11 and outputs the data to the controller 11 via the output terminal 54. The amplifier 53 is not included in each cell 40; instead, a single amplifier 53 is included in the CMOS image sensor 14, as will be described below.

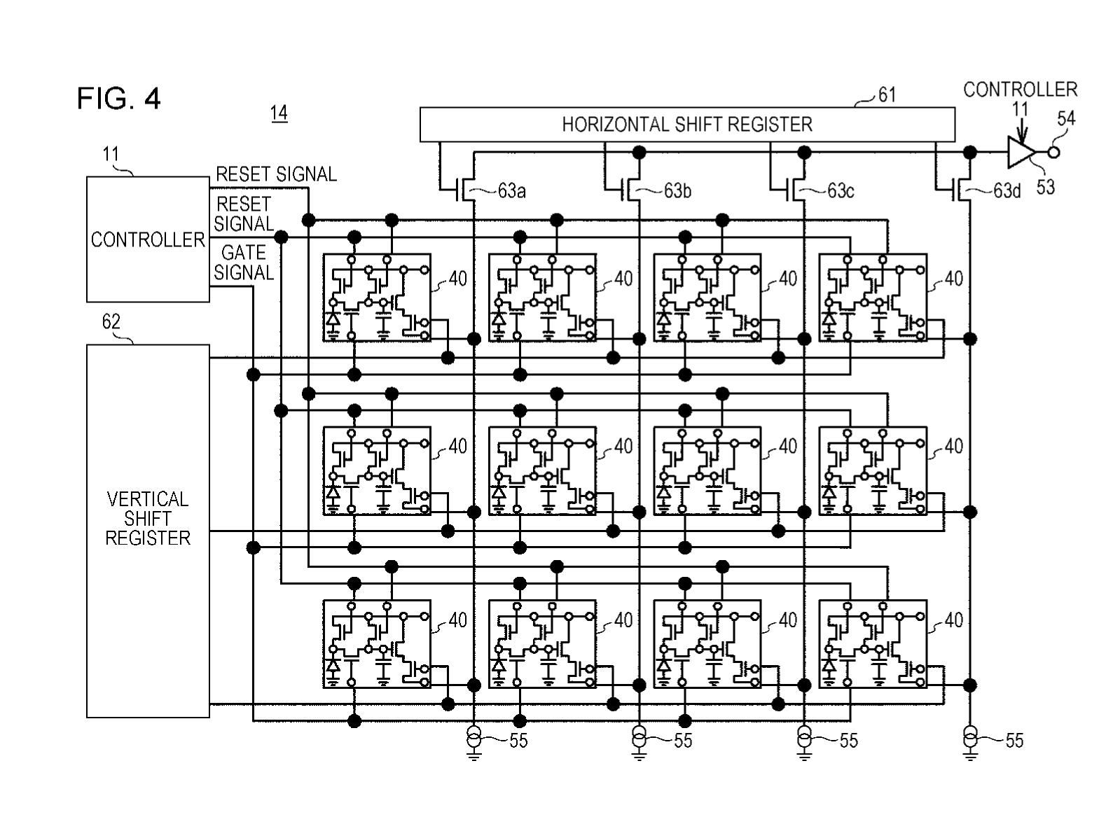

FIG. 4 illustrates the configuration of the CMOS image sensor 14.

In FIG. 4, the CMOS image sensor 14 includes 12 cells 40, a horizontal shift register 61, a vertical shift register 62, column-selecting transistors 63a to 63d, and four constant current sources 55. The horizontal shift register 61 outputs a column selection signal to the column-selecting transistor 63a when data stored in three cells 40 in the first column are to be read. Similarly, when data stored in three cells 40 in the second column are to be read, the horizontal shift register 61 outputs a column selection signal to the column-selecting transistor 63b. When data stored in three cells 40 in the third column are to be read, the horizontal shift register 61 outputs a column selection signal to the column-selecting transistor 63c. When data stored in three cells 40 in the fourth column are to be read, the horizontal shift register 61 outputs a column selection signal to the column-selecting transistor 63d.

The vertical shift register 62 outputs a row selection signal to the row-selecting transistor 50 in each of four cells 40 in the first row when data stored in the cells 40 in the first row are to be read. When data stored in four cells 40 in the second row are to be read, the vertical shift register 62 outputs a row selection signal to the row-selecting transistor 50 in each of the cells 40 in the second row. When data stored in four cells 40 in the third row are to be read, the vertical shift register 62 outputs a row selection signal to the row-selecting transistor 50 in each of the cells 40 in the third row.

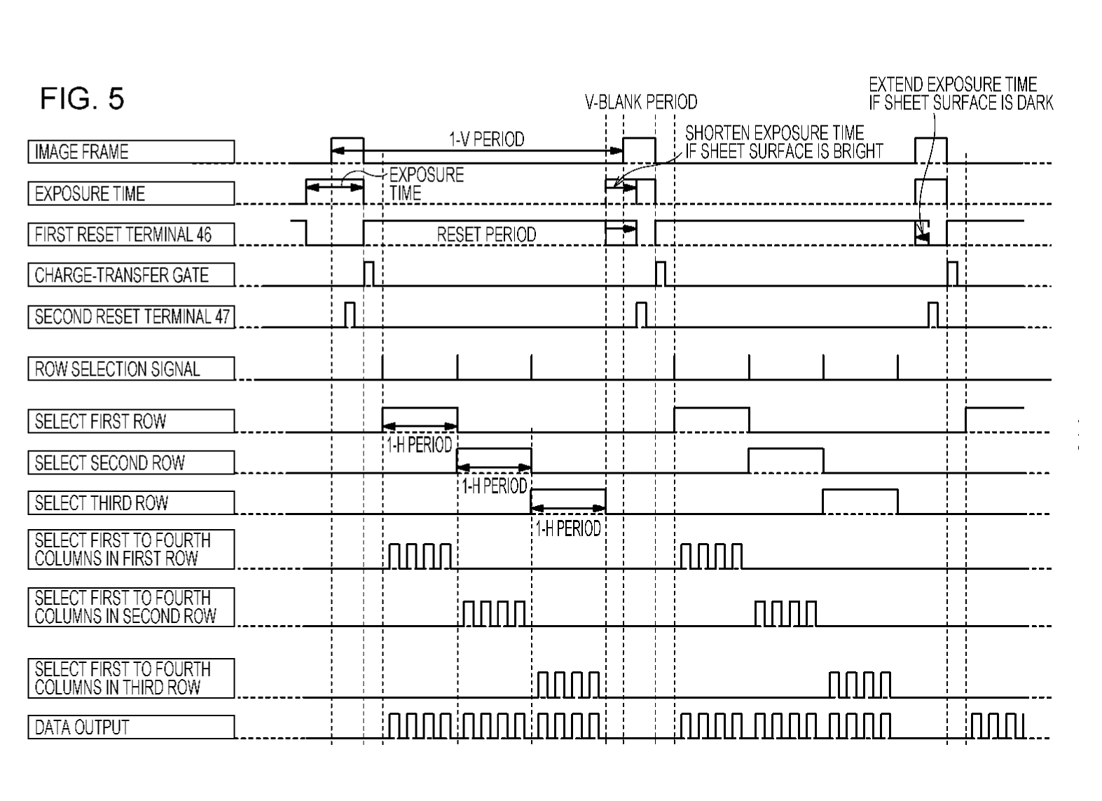

FIG. 5 is a timing chart illustrating an operational state of the CMOS image sensor 14.

In FIG. 5, an image frame is input for every period of a vertical synchronizing signal. The controller 11 outputs a reset signal to the reset terminal 46 to adjust a reset period, thereby adjusting the exposure time of the CMOS image sensor 14. For example, if the sheet 3 has a bright surface (i.e., if the quantity of received light is large), the controller 11 shortens the exposure time so as to prevent saturation in the output from the CMOS image sensor 14. If the sheet 3 has a dark surface (i.e., if the quantity of received light is small), the controller 11 extends the exposure time so as to increase the output from the CMOS image sensor 14. Just before outputting the reset signal to the reset terminal 46, the controller 11 outputs a signal for turning on the charge-transfer switch 44 to the charge-transfer gate 45 so as to store an electric charge in the charge-storage capacitor 49. Furthermore, the controller 11 outputs a reset signal to the reset terminal 47 at a timing within the exposure time of the CMOS image sensor 14 so as to initialize the charge-storage capacitor 49.

The vertical shift register 62 outputs row selection signals corresponding to three rows within one frame period. A period from a point at which a row selection signal is output to a point at which a subsequent row selection signal is output corresponds to one period of a horizontal synchronizing signal. Within one period of this horizontal synchronizing signal, the horizontal shift register 61 outputs four column selection signals corresponding to four cells included in a single row to the respective column-selecting transistors 63a to 63d. As a result, data are read from the 12 cells 40 within the reset period.

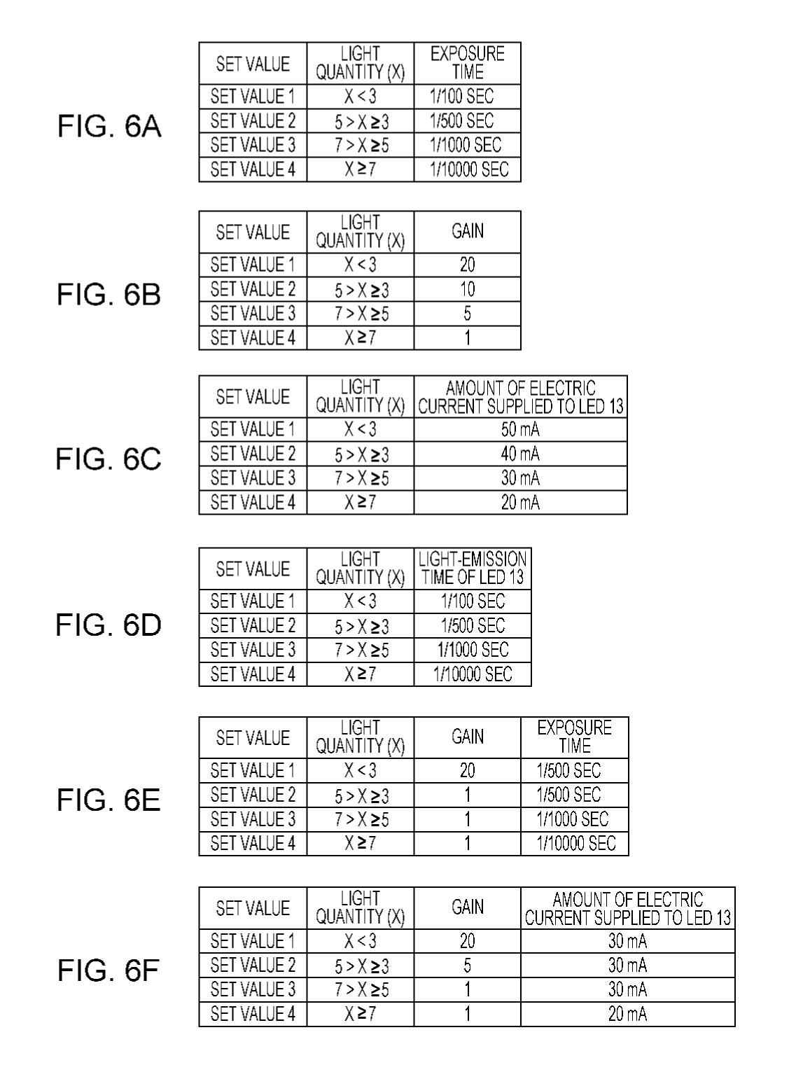

FIGS. 6A to 6F illustrate examples of table information stored in the memory 35.

In FIGS. 6A to 6F, a set value is a value set in the light-emission control unit 32 or the light-reception control unit 33 by the overall control unit 31 in the controller 11. In FIGS. 6A to 6F, a light quantity indicates a threshold value for the light quantity of data from the CMOS image sensor 14 detected by the overall control unit 31. The exposure time of the CMOS image sensor 14, the gain of the CMOS image sensor 14, the amount of electric current supplied to the LED 13, and the light-emission time of the LED 13 are objects to be controlled by the overall control unit 31.

For example, in FIG. 6A, when the light quantity of the data from the CMOS image sensor 14 is lower than “3”, the overall control unit 31 sets information indicating an exposure time of 1/100 seconds as a set value 1 in the light-reception control unit 33. In this case, the light-reception control unit 33 controls a reset signal to be transmitted to the transistor 42 so that the exposure time of the CMOS image sensor 14 is equal to 1/100 seconds.

For example, in FIG. 6B, when the light quantity of the data from the CMOS image sensor 14 is lower than “3”, the overall control unit 31 sets information indicating a gain of “20” as a set value 1 in the light-reception control unit 33. In this case, the light-reception control unit 33 controls the amplifier 53 so that the gain of the CMOS image sensor 14 is equal to 20. A maximum output of the CMOS image sensor 14 is set to be 10.

For example, in FIG. 6C, when the light quantity of the data from the CMOS image sensor 14 is lower than “3”, the overall control unit 31 sets information indicating an electric current of 50 mA as a set value 1 in the light-emission control unit 32. In this case, the light-emission control unit 32 controls the amount of electric current supplied to the LED 13 so that the electric current supplied to the LED 13 is equal to 50 mA.

For example, in FIG. 6D, when the light quantity of the data from the CMOS image sensor 14 is lower than “3”, the overall control unit 31 sets information indicating a light-emission time of 1/100 seconds as a set value 1 in the light-emission control unit 32. In this case, the light-emission control unit 32 controls a duty ratio of the electric current supplied to the LED 13 so that the light-emission time of the LED 13 is equal to 1/100 seconds. As a matter of course, the LED 13 emits light during the exposure time of the CMOS image sensor 14.

As shown in FIGS. 6A to 6D, the overall control unit 31 controls at least one of the exposure time of the CMOS image sensor 14, the gain of the CMOS image sensor 14, the amount of electric current supplied to the LED 13, and the light-emission time of the LED 13 on the basis of the light quantity of the data from the CMOS image sensor 14. Accordingly, fluctuations in the output from the CMOS image sensor 14 are minimized.

Referring to FIG. 6E, the overall control unit 31 may control a combination of the exposure time and the gain of the CMOS image sensor 14 on the basis of the light quantity of the data from the CMOS image sensor 14. In this case, the overall control unit 31 adjusts the sensitivity of the CMOS image sensor 14 by changing the gain value of the CMOS image sensor 14 and also adjusts the sensitivity of the CMOS image sensor 14 by changing the value of the exposure time. Furthermore, referring to FIG. 6F, the overall control unit 31 may control a combination of the gain of the CMOS image sensor 14 and the amount of electric current supplied to the LED 13 on the basis of the light quantity of the data from the CMOS image sensor 14. In this case, the overall control unit 31 adjusts the sensitivity of the CMOS image sensor 14 by changing the gain value of the CMOS image sensor 14 and also adjusts the sensitivity of the CMOS image sensor 14 by changing the amount of electric current supplied to the LED 13. A combination to be controlled by the overall control unit 31 may include at least two of the exposure time of the CMOS image sensor 14, the gain of the CMOS image sensor 14, the amount of electric current supplied to the LED 13, and the light-emission time of the LED 13.

The table information shown in each of FIGS. 6A to FIG. 6F is merely an example and is not limited thereto. For example, the threshold values for the light quantity and the set values in the table information may be set as more detailed values.

Moreover, for example, the digital pen 1 may include a switch corresponding to a setting unit that sets table information to be used from among multiple pieces of table information stored in the memory 35. This switch is connected to the overall control unit 31. Alternatively, the overall control unit 31 may receive a setting command for setting table information to be used from the PC 2 via the communication I/F 16 and set this table information in the overall control unit 31 itself in response to the setting command.

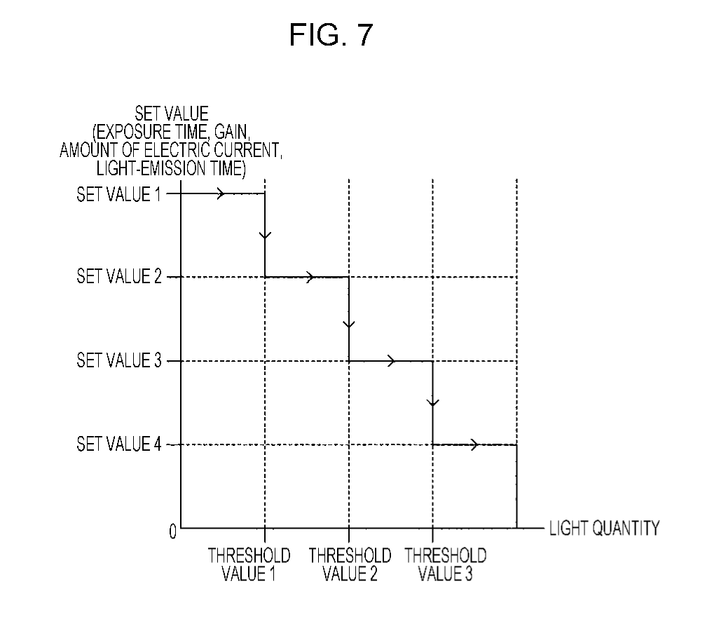

FIG. 7 illustrates the relationship between light-quantity values and set values included in each piece of table information shown FIGS. 6A to 6F. In FIG. 7, the ordinate denotes set values (set values 1 to 4 in FIGS. 6A to 6F), whereas the abscissa denotes light-quantity values. For example, threshold values 1 to 3 correspond to light-quantity values “3”, “5”, and “7” in FIGS. 6A to 6F.

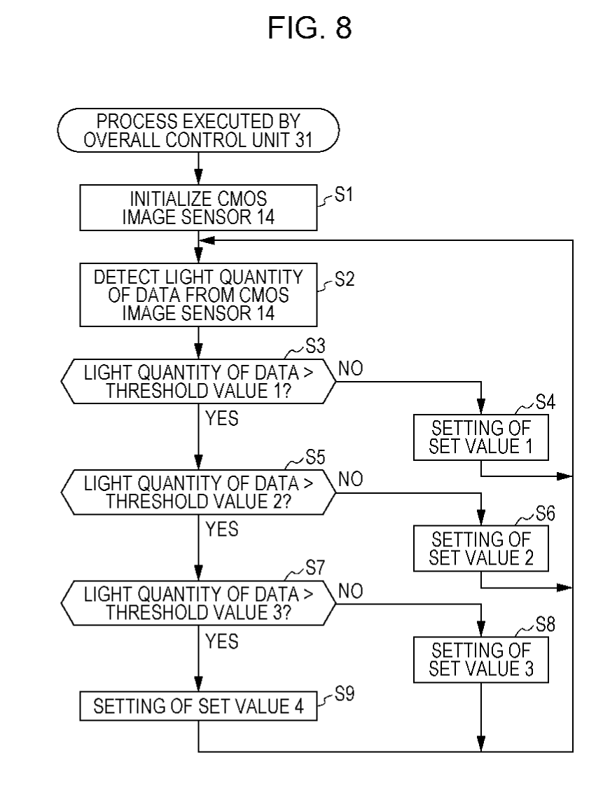

FIG. 8 is a flow chart illustrating a process executed by the overall control unit 31. The process is based on the relationship, shown in FIG. 7, between light-quantity values and set values included in the table information.

First, in step S1, the overall control unit 31 causes the light-reception control unit 33 to initialize the CMOS image sensor 14. For example, the CMOS image sensor 14 is reset, and the set value 1 is set in the light-reception control unit 33.

In step S2, the overall control unit 31 detects a light quantity of data from the CMOS image sensor 14. In step S3, the overall control unit 31 determines whether or not the light quantity of the data from the CMOS image sensor 14 is greater than the threshold value 1 for the light quantity included in the table information. If the determination result in step S3 indicates “NO”, the overall control unit 31 sets the set value 1 in the light-emission control unit 32 and/or the light-reception control unit 33 in step S4. The process then returns to step S2.

If the determination result in step S3 indicates “YES”, the overall control unit 31 determines whether or not the light quantity of the data from the CMOS image sensor 14 is greater than the threshold value 2 for the light quantity included in the table information in step S5. If the determination result in step S5 indicates “NO”, the overall control unit 31 sets the set value 2 in the light-emission control unit 32 and/or the light-reception control unit 33 in step S6. The process then returns to step S2.

If the determination result in step S5 indicates “YES”, the overall control unit 31 determines whether or not the light quantity of the data from the CMOS image sensor 14 is greater than the threshold value 3 for the light quantity included in the table information in step S7. If the determination result in step S7 indicates “NO”, the overall control unit 31 sets the set value 3 in the light-emission control unit 32 and/or the light-reception control unit 33 in step S8. The process then returns to step S2. If the determination result in step S7 indicates “YES”, the overall control unit 31 sets the set value 4 in the light-emission control unit 32 and/or the light-reception control unit 33 in step S9. The process then returns to step S2.

The overall control unit 31 executes step S2 to step S9 every time new data (i.e., a new image frame) is input from the CMOS image sensor 14. The light-emission control unit 32 and/or the light-reception control unit 33 in which the set values are set in steps S4, S6, S8, and S9 control/controls at least one of the exposure time of the CMOS image sensor 14, the gain of the CMOS image sensor 14, the amount of electric current supplied to the LED 13, and the light-emission time of the LED 13 in accordance with the table information.

Accordingly, in FIGS. 7 and 8, every time new data (i.e., a new image frame) is input from the CMOS image sensor 14, the overall control unit 31 controls at least one of the exposure time of the CMOS image sensor 14, the gain of the CMOS image sensor 14, the amount of electric current supplied to the LED 13, and the light-emission time of the LED 13 on the basis of the magnitude relationship between the light quantity of the data from the CMOS image sensor 14 and the threshold values for the light quantity included in the table information. Thus, fluctuations in the output from the CMOS image sensor 14 are minimized.

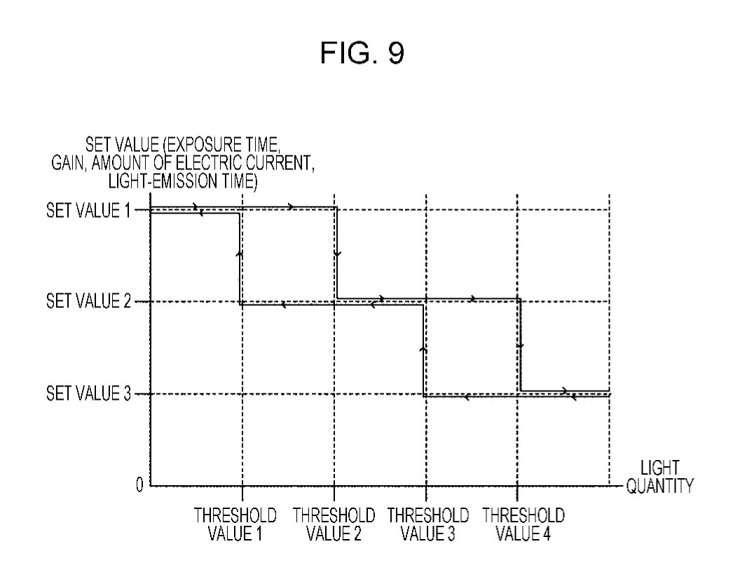

FIG. 9 illustrates another example of the relationship between light-quantity values and set values included in each piece of table information. In FIG. 9, the ordinate denotes set values, whereas the abscissa denotes light-quantity values. In this case, the table information includes three set values and four threshold values for the light quantity. The overall control unit 31 controls at least one of the exposure time of the CMOS image sensor 14, the gain of the CMOS image sensor 14, the amount of electric current supplied to the LED 13, and the light-emission time of the LED 13.

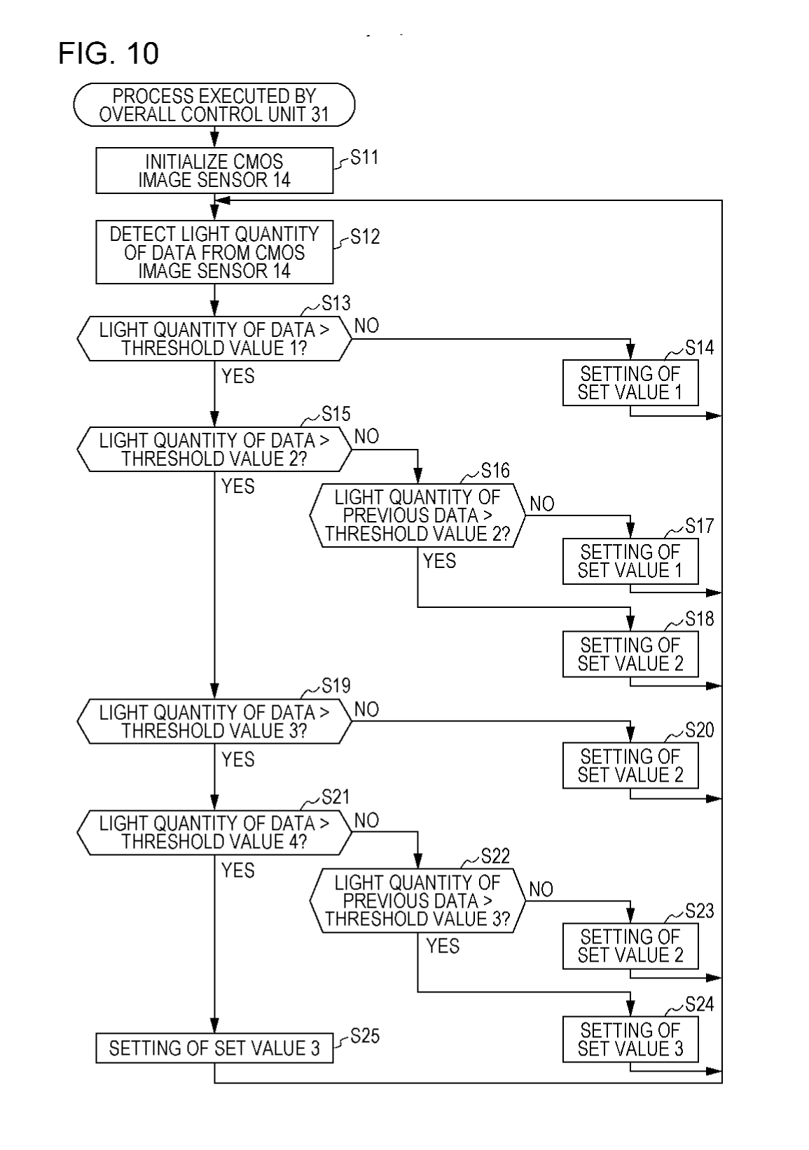

FIG. 10 is a flow chart illustrating another example of a process executed by the overall control unit 31. The process is based on the relationship, shown in FIG. 9, between light-quantity values and set values included in the table information.

First, in step S11, the overall control unit 31 causes the light-reception control unit 33 to initialize the CMOS image sensor 14. For example, the CMOS image sensor 14 is reset, and the set value 1 is set in the light-reception control unit 33.

In step S12, the overall control unit 31 detects a light quantity of data from the CMOS image sensor 14. In this case, the detected value is registered as previous data only the first time. In step S13, the overall control unit 31 determines whether or not the light quantity of the data from the CMOS image sensor 14 is greater than the threshold value 1 for the light quantity included in the table information. If the determination result in step S13 indicates “NO”, the overall control unit 31 sets the set value 1 in the light-emission control unit 32 and/or the light-reception control unit 33 in step S14. The process then returns to step S12.

If the determination result in step S13 indicates “YES”, the overall control unit 31 determines whether or not the light quantity of the data from the CMOS image sensor 14 is greater than the threshold value 2 for the light quantity included in the table information in step S15. If the determination result in step S15 indicates “NO”, the overall control unit 31 determines whether or not the light quantity of the previous data from the CMOS image sensor 14 is greater than the threshold value 2 for the light quantity included in the table information in step S16. If the determination result in step S16 indicates “NO”, the overall control unit 31 sets the set value 1 in the light-emission control unit 32 and/or the light-reception control unit 33 in step S17. The process then returns to step S12. If the determination result in step S16 indicates “YES”, the overall control unit 31 sets the set value 2 in the light-emission control unit 32 and/or the light-reception control unit 33 in step S18. The process then returns to step S12.

If the determination result in step S15 indicates “YES”, the overall control unit 31 determines whether or not the light quantity of the data from the CMOS image sensor 14 is greater than the threshold value 3 for the light quantity included in the table information in step S19. If the determination result in step S19 indicates “NO”, the overall control unit 31 sets the set value 2 in the light-emission control unit 32 and/or the light-reception control unit 33 in step 520. The process then returns to step S12.

If the determination result in step S19 indicates “YES”, the overall control unit 31 determines whether or not the light quantity of the data from the CMOS image sensor 14 is greater than the threshold value 4 for the light quantity included in the table information in step S21. If the determination result in step S21 indicates “NO”, the overall control unit 31 determines whether or not the light quantity of the previous data from the CMOS image sensor 14 is greater than the threshold value 3 for the light quantity included in the table information in step S22. If the determination result in step S22 indicates “NO”, the overall control unit 31 sets the set value 2 in the light-emission control unit 32 and/or the light-reception control unit 33 in step S23. The process then returns to step S12. If the determination result in step S22 indicates “YES”, the overall control unit 31 sets the set value 3 in the light-emission control unit 32 and/or the light-reception control unit 33 in step S24. The process then returns to step S12.

If the determination result in step S21 indicates “YES”, the overall control unit 31 sets the set value 3 in the light-emission control unit 32 and/or the light-reception control unit 33 in step S25. The process then returns to step S12.

The overall control unit 31 executes step S12 to step S25 every time new data (i.e., a new image frame) is input from the CMOS image sensor 14. Furthermore, the light-emission control unit 32 and/or the light-reception control unit 33 in which the set values are set in steps S14, S17, S18, S20, and S23 to S25 control/controls at least one of the exposure time of the CMOS image sensor 14, the gain of the CMOS image sensor 14, the amount of electric current supplied to the LED 13, and the light-emission time of the LED 13 in accordance with the table information.

Accordingly, in FIGS. 9 and 10, every time new data (i.e., a new image frame) is input from the CMOS image sensor 14, the overall control unit 31 controls at least one of the exposure time of the CMOS image sensor 14, the gain of the CMOS image sensor 14, the amount of electric current supplied to the LED 13, and the light-emission time of the LED 13 on the basis of the magnitude relationship between the light quantity of the data from the CMOS image sensor 14 and the threshold values for the light quantity included in the table information as well as the magnitude relationship between the light quantity of the previous data from the CMOS image sensor 14 and the threshold values for the light quantity included in the table information. Thus, fluctuations in the output from the CMOS image sensor 14 are further minimized, as compared with the case in FIGS. 7 and 8.

As described above, in this exemplary embodiment, every time the overall control unit 31 receives new data (i.e., a new image frame) from the CMOS image sensor 14, the overall control unit 31 controls the operation of the LED 13 or the CMOS image sensor 14 on the basis of the light quantity of the data input from the CMOS image sensor 14 detected by the overall control unit 31 and the table information. Therefore, the digital pen 1 minimizes fluctuations in the output from the CMOS image sensor 14, which may occur depending on the state and the environment in which the digital pen 1 is used, whereby the digital pen 1 may accurately read an image. In addition, the image decoding process may be stably performed since the sensitivity of the CMOS image sensor 14 is adjusted.

Furthermore, because the digital pen 1 uses table information to adjust the exposure time of the CMOS image sensor 14, the exposure time of the CMOS image sensor 14 is not controlled using feedback control that requires complicated calculations as in the related art. Thus, the digital pen 1 may read an image at high speed (i.e., may have high-speed responsiveness). Furthermore, the occurrence of limit cycle oscillation may be prevented in the digital pen 1.

A storage medium that stores a software program for achieving the function of the digital pen 1 may be supplied to the PC 2, and the controller 11 may read the program stored in the storage medium from the PC 2 and execute the program. Examples of the storage medium for supplying the program include a CD-ROM, a DVD, and an SD card.

Furthermore, the controller 11 may execute the software program for achieving the function of the digital pen 1.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electronic writing device comprising:
a light source that emits light to a recording medium;
an image sensor that receives the light reflected from the recording medium as image data;
a detecting unit that detects a light quantity of the image data received by the image sensor;
table information in which a light-quantity range and a control object for the image sensor or the light source are associated with each other, the light-quantity range being segmented into a plurality of threshold values; and
a controller that controls operation of the image sensor or the light source, every time the image sensor receives new image data, on the basis of the light quantity of the image data detected by the detecting unit and the table information.

2. The electronic writing device according to claim 1, wherein the control object for the image sensor or the light source includes at least one of an exposure time of the image sensor, a gain of the image sensor, an amount of electric current supplied to the light source, and a light-emission time of the light source.

3. The electronic writing device according to claim 2, wherein the control object for the image sensor or the light source is a combination of at least two of the exposure time of the image sensor, the gain of the image sensor, the amount of electric current supplied to the light source, and the light-emission time of the light source.

4. The electronic writing device according to claim 3, wherein the control object for the image sensor or the light source is a combination of the exposure time of the image sensor and the light-emission time of the light source.

5. The electronic writing device according to claim 1, wherein the controller controls the operation of the image sensor or the light source, every time the image sensor receives the new image data, on the basis of the light quantity of the image data detected by the detecting unit, the light quantity of previous image data detected by the detecting unit, and the table information.

6. The electronic writing device according to claim 2, wherein the controller controls the operation of the image sensor or the light source, every time the image sensor receives the new image data, on the basis of the light quantity of the image data detected by the detecting unit, the light quantity of previous image data detected by the detecting unit, and the table information.

7. The electronic writing device according to claim 3, wherein the controller controls the operation of the image sensor or the light source, every time the image sensor receives the new image data, on the basis of the light quantity of the image data detected by the detecting unit, the light quantity of previous image data detected by the detecting unit, and the table information.

8. The electronic writing device according to claim 1, wherein the table information includes a plurality of pieces of table information, and
wherein the electronic writing device further comprises a setting unit that sets table information to be used from among the plurality of pieces of table information.

9. The electronic writing device according to claim 2, wherein the table information includes a plurality of pieces of table information, and
wherein the electronic writing device further comprises a setting unit that sets table information to be used from among the plurality of pieces of table information.

10. The electronic writing device according to claim 3, wherein the table information includes a plurality of pieces of table information, and
wherein the electronic writing device further comprises a setting unit that sets table information to be used from among the plurality of pieces of table information.

11. The electronic writing device according to claim 4, wherein the table information includes a plurality of pieces of table information, and
wherein the electronic writing device further comprises a setting unit that sets table information to be used from among the plurality of pieces of table information.

12. The electronic writing device according to claim 5, wherein the table information includes a plurality of pieces of table information, and
wherein the electronic writing device further comprises a setting unit that sets table information to be used from among the plurality of pieces of table information.

13. The electronic writing device according to claim 6, wherein the table information includes a plurality of pieces of table information, and
wherein the electronic writing device further comprises a setting unit that sets table information to be used from among the plurality of pieces of table information.

14. A computer readable medium storing a program causing a computer to execute an electronic writing process, the computer being connected to a light source that emits light to a recording medium and also connected to an image sensor that receives the light reflected from the recording medium as image data, the process comprising:
detecting a light quantity of the image data received by the image sensor;
storing table information in which a light-quantity range and a control object for the image sensor or the light source are associated with each other, the light-quantity range being segmented into a plurality of threshold values; and
controlling operation of the image sensor or the light source, every time the image sensor receives new image data, on the basis of the light quantity of the image data detected by the detecting unit and the table information.

15. An electronic writing method comprising:
emitting light to a recording medium;
receiving the light reflected from the recording medium as image data;
detecting a light quantity of the received image data;
storing table information in which a light-quantity range and a control object are associated with each other, the light-quantity range being segmented into a plurality of threshold values; and
performing control, every time new image data is received, on the basis of the detected light quantity of the image data and the table information.

16. The electronic writing device according to claim 1, wherein the light source includes at least one light emitting diode.

17. The electronic writing device according to claim 1, wherein the image sensor is a CMOS image sensor.

18. The electronic writing device according to claim 1, further comprising a pressure sensor that detects a writing movement of the electronic writing device based on a pressure applied to a tip of the electronic writing device.

19. The electronic writing device according to claim 1, further comprising an information memory that stores identification information and positional information.

20. The electronic writing device according to claim 1, further comprising a communication interface that communicates with an external device.
